(19) United States
(12) Patent Application Publication
(10) Pub. No.: US 2026/0141706 A1
(43) Pub. Date: May 21, 2026

(54) OBJECT RE-IDENTIFICATION APPARATUS, OBJECT RE-IDENTIFICATION METHOD THEREOF, AND MODEL LEARNING METHOD THEREOF

(71) Applicants: Hyundai Motor Company, Seoul (KR); Kia Corporation, Seoul (KR); Singapore University of Technology and Design, Singapore (SG)

(72) Inventors: Evan Ling, Singapore (SG); Xiaofei Hui, Shandong (CN); Jun Liu, Lancaster (GB); Dezhao Huang, Singapore (SG); Pengfei Wang, Singapore (SG)

(21) Appl. No.: 19/213,878

(22) Filed: May 20, 2025

(30) Foreign Application Priority Data
Nov. 20, 2024 (KR) 10-2024-0166659

(51) Int. Cl. G06V 10/82; G06V 10/77; G06V 20/40

(52) U.S. Cl. CPC G06V 10/82; G06V 10/7715; G06V 20/41; G06V 20/46

(57) ABSTRACT

Object re-identification technology is used to track images, in which an object re-identification apparatus, an object re-identification method, and a model learning method can improve object re-identification performance through the use of a model trained based on spatially and temporally refined features. The object re-identification method includes extracting a first feature from an input video frame, and extracting a second feature by segmenting the first feature based on an expert module within multiple expert layers in a sequential relationship, where the expert module is a single expert module activated among multiple expert modules of a single expert layer.

### CROSS REFERENCE TO RELATED APPLICATION

The present application claims under 35 U.S.C. § 119(a) the benefit of Korean Patent Application No. 10-2024-0166659, filed Nov. 20, 2024, the entire contents of which are incorporated by reference herein.

### BACKGROUND

### (a) Technical Field

The present disclosure relates to object re-identification technology within images, and more particularly, to an object re-identification apparatus, an object re-identification method, and a model learning method that utilize a model trained based on spatially and temporally refined features to improve object re-identification performance.

### (b) Description of the Related Art

Object re-identification (re-ID) technology is a technique that detects and tracks the same object (e.g., person, vehicle, etc.) in videos captured by multiple different cameras, aiming to identify whether the object is present in videos captured by different cameras or by the same camera at different times.

To confirm the presence of the same object across multiple videos, it is crucial to utilize refined features.

Methods for exploring refined features include attention-based methods and part-level methods.

Traditional approaches train model parameters based on all samples in a dataset. However, refined components necessary to distinguish very similar samples (e.g., a logo on a shirt) may only exist in a subset of samples.

When model parameters are updated based on all samples in the dataset, refined components present in a subset of samples can be overlooked.

Therefore, there is a need for an approach that effectively learns refined components, which are key factors in distinguishing samples.

The related art described above is intended merely to aid in the understanding of the background of the disclosure, and should not be construed as recognizing the prior art that is known to those skilled in the art.

### SUMMARY

The present disclosure proposes an object re-identification apparatus, a corresponding object re-identification method, and a model learning method that are capable of effectively learning detailed components (fine features), which are crucial factors in distinguishing samples.

The disclosure provides an object re-identification apparatus, a corresponding object re-identification method, and a model learning method capable of effectively learning both learning spatially and temporally refined differences.

The disclosure provides an expert-scalable object re-identification apparatus, an object re-identification method, and a model learning method that are capable of automatically incorporating new experts during training.

The technical objects of the disclosure are not limited to the aforesaid, and other objects not described herein with be clearly understood by those skilled in the art from the descriptions below.

In order to accomplish the above objects, the disclosed object re-identification apparatus may include a memory configured to store an object re-identification model and a processor configured to execute the model.

According to an embodiment, the processor may extract a first feature from a video frame input, segment the first feature into a second feature based on an expert module within multiple expert layers in a sequential relationship, and classify the second feature in the object re-identification model, the expert module being a single expert module activated among multiple expert modules within a single expert layer.

According to an embodiment, the expert module may be a single expert module generated during the implementation of the model or an expert model added during training.

According to an embodiment, the expert module may be an expert module generated during the implementation of the model or an expert model added during training.

According to an embodiment, the expert module within a first expert layer may extract segmented features based on the first feature, and the expert modules within the remaining expert layers may extract segmented features based on the features output from the expert module of the preceding expert layer.

According to an embodiment, the expert module may have the highest relevance to the input video among multiple expert modules within the single expert layer.

According to an embodiment, the expert module may selectively extract a spatially segmented feature or a temporally segmented feature based on spatial-temporal importance of an input feature.

According to an embodiment, the expert module may include an importance evaluation module configured to output an importance vector based on the input feature, a branching module configured to output the input feature to a spatial feature channel or a temporal feature channel based on the importance vector, a spatial feature extraction module configured to extract spatial features segmented based on the feature input through the spatial feature channel, and a temporal feature extraction module configured to extract temporal features segmented based on the feature input through the temporal feature channel.

According to an embodiment, the importance evaluation module may output the importance vector including an importance value for the input feature using max-pooling and a fully-connected layer.

According to an embodiment, the branching module may generate a binary decision vector based on the importance vector, output the input feature to the spatial feature channel based on the binary decision vector being 1, and output the input feature to the temporal feature channel based on the binary decision vector being 0.

According to an embodiment, the processor may include a selector configured to activate one of the multiple expert modules within the single expert layer based on relevance scores of the multiple expert modules within the single expert layers during training.

According to an embodiment, the processor may include a waiting expert module associated with the single expert layer.

According to an embodiment, the waiting expert module may be selectively included in the single expert layer during training.

An object re-identification method according to an embodiment of the disclosure may include extracting a first feature from an input video frame, extracting a second feature by segmenting the first feature based on an expert module within multiple expert layers in a sequential relationship, and classifying the second feature in the object re-identification model.

According to an embodiment, the expert module may be a single expert module generated during the implementation of the model or an expert model added during training.

According to an embodiment, the extracting of the second feature may include extracting, by the expert module within a first expert layer, segmented features based on the first feature, and extracting, by expert modules within the remaining expert layers, segmented features based on the feature output from the expert module of the preceding expert layer.

According to an embodiment, the feature extracted by the expert module within the last expert layer may be the second feature.

According to an embodiment, the extracting of the second feature may include selectively extracting, by the expert module, a spatially segmented feature or a temporally segmented feature based on spatial-temporal importance of an input feature.

According to an embodiment, the extracting of the second feature may include extracting an importance vector based on an input feature, outputting the input feature to a spatial feature channel or a temporal feature channel based on the importance vector, and extracting spatial features segmented based on the feature input through the spatial feature channel or temporal features segmented based on the feature input through the temporal feature channel.

According to an embodiment, the extracting of the second feature may include generating a binary decision vector based on an importance vector.

According to an embodiment, the outputting of the input feature to the spatial feature channel or temporal feature channel may include outputting the input feature to the spatial feature channel based on the binary decision vector being 1 and outputting the input feature to the temporal feature channel based on the binary decision vector being 0.

According to an embodiment of the disclosure, a model learning method of an object re-identification apparatus may include extracting a feature based on an input sample, activating an expert module for each of multiple expert layers in a sequential relationship based on the feature, extracting, after activating the expert module, segmented features based on the feature extracted from the input sample using the activated expert module, calculating loss based on the segmented features, and updating the model based on the loss.

According to an embodiment, the activating of the expert module may include activating, by a first expert layer among multiple expert layers, one of multiple expert modules based on the feature, and activating, by the remaining expert layers among the multiple expert layers, one of the multiple expert modules based on the feature output from a preceding expert layer.

According to an embodiment, the activating of the expert module may include evaluating, by the multiple expert module of each of the multiple expert layers, an input feature and a relevance score of the expert module, and activating, by a selector of each of the multiple expert modules, the expert module with the highest relevance score within the corresponding expert layer.

According to an embodiment, the extracting of the segmented features may include evaluating, by the activated expert module, spatial-time importance of the input feature, and extracting spatially segmented features or temporally segmented features based on the evaluation.

According to an embodiment, the calculating of the loss may include vectorizing a spatial feature parameter or temporal feature parameter output from the activated expert module, and calculating loss for the spatial feature and loss for the temporal feature by computing the pairwise cosine similarity based on the vectorized spatial and temporal feature parameters for each expert layer.

The object re-identification apparatus, object re-identification method, and model learning method disclosed in the embodiments are advantageous in terms of effectively learning detailed features, which are crucial factors in distinguishing images.

The object re-identification apparatus, object re-identification method, and model learning method disclosed in the embodiments are also advantageous in terms of learning spatially refined features or temporally refined features dewaiting on whether the features are important in spatial or temporal aspects.

Therefore, the object re-identification apparatus (or object re-identification method) disclosed in the embodiments possesses the expertise to distinguish small differences and enhance the discriminative performance for images.

Additionally, the object re-identification apparatus, object re-identification method, and model learning method are also advantageous in terms of automatically adding and expanding new experts during training.

Consequently, this eliminates the hassle of workers manually assigning additional experts and the burden of conducting extensive testing to determine the appropriate number of experts.

The advantages of the disclosure are not limited to the aforesaid, and other advantages not described herein may be clearly understood by those skilled in the art from the descriptions below.

### BRIEF DESCRIPTION OF THE DRAWINGS

FIG. 1 is a diagram illustrating the configuration of an object re-identification apparatus according to an embodiment of the disclosure;

FIG. 2 is a block diagram illustrating function blocks of a processor according to an embodiment of the disclosure;

FIG. 3 is a diagram illustrating the detailed configuration of a feature extraction module according to an embodiment of the disclosure;

FIG. 4 is a diagram illustrating the detailed configuration of an expert module in FIG. 3;

FIG. 5 is a flowchart illustrating an object re-identification method according to an embodiment of the disclosure.

FIG. 6 is a flowchart illustrating detailed operations at S510-1 to S510-N in FIG. 5; and

FIG. 7 is a flowchart illustrating a method for training an object re-identification model according to an embodiment of the disclosure.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In addition, detailed descriptions of well-known technologies related to the embodiments disclosed in the present specification may be omitted to avoid obscuring the subject matter of the embodiments disclosed in the present specification. In addition, the accompanying drawings are only for easy understanding of the embodiments disclosed in the present specification and do not limit the technical spirit disclosed herein, and it should be understood that the embodiments include all changes, equivalents, and substitutes within the spirit and scope of the disclosure.

As used herein, terms including an ordinal number such as “first” and “second” can be used to describe various components without limiting the components. The terms are used only for distinguishing one component from another component.

The singular forms are intended to include the plural forms as well unless the context clearly indicates otherwise.

It will be understood that when a component is referred to as being “connected to” or “coupled to” another component, it can be directly connected or coupled to the other component or intervening component may be present. In contrast, when a component is referred to as being “directly connected to” or “directly coupled to” another component, there are no intervening component present.

Hereinafter, descriptions are made of the embodiments disclosed in the present specification with reference to the accompanying drawings in which the same reference numbers are assigned to refer to the same or like components and redundant description thereof is omitted.

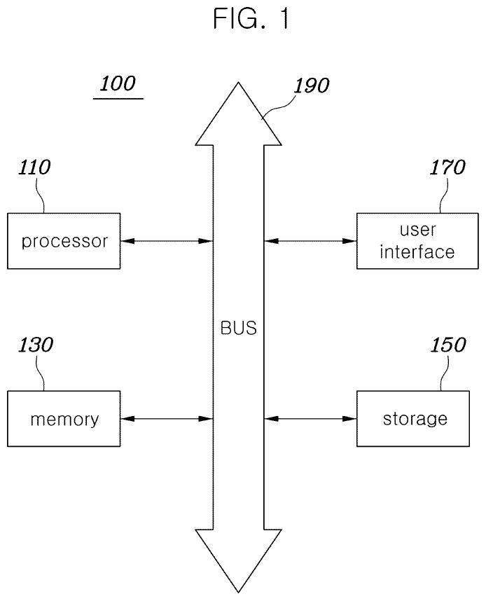

FIG. 1 is a diagram illustrating the configuration of an object re-identification apparatus 100 according to an embodiment of the disclosure.

With reference to FIG. 1, the object re-identification apparatus 100 according to an embodiment of the disclosure may be a computing device implemented to perform object re-identification based on the input video sequence.

For example, the video sequence may be input from a single camera or from multiple cameras.

The object re-identification apparatus 100 may perform object re-identification on video sequences based on an object re-identification model with a neural network structure of artificial intelligence.

The object re-identification model of the object re-identification apparatus 100 may be updated through training.

According to an embodiment, the object re-identification model may effectively learn the detailed components (or features) of samples and may effectively learn spatially refined differences and temporally refined differences.

Additionally, the object re-identification model may automatically add new experts during training. In this way, due to the capability of expanding expert during training, the object re-identification model may alleviate the hassle of manually assigning experts and the effort required to conduct extensive testing to determine the appropriate number of experts.

According to an embodiment, the object re-identification apparatus 100 may include a processor 110, memory 130, storage 150, a user interface 170, and a bus 190.

The processor 110 be implemented as a hardware data processing device implemented with a physical structure to execute desired operations.

The processor 110 controls the overall operation of each component of the object re-identification apparatus 100. The processor 110 may be configured to include at least one of central processing unit (CPU), microprocessor unit (MPU), micro controller unit (MCU), graphic processing unit (GPU), or any form of processor well known in the art of the disclosure.

In addition, the processor 110 may perform calculations for at least one application or program to execute methods/operations according to various embodiments of the disclosure.

The memory 130 stores various data, commands, and/or information. The memory 130 may load one or more computer programs from the storage 150 to execute methods/operations according to various embodiments of the disclosure. For example, the memory 130 may store an object re-identification model that is executed by the processor 110.

Examples of the memory 130 may include random access memory (RAM) and dynamic RAM (DRAM), but are not limited thereto, and may include at least one form of memory known in the art of the disclosure.

The storage 150 may temporarily store one or more computer programs. For example, the storage 150 may be composed of non-volatile memory such as flash memory, hard disk, removable disk, or any other form of computer-readable recording medium known in the art of the disclosure.

For example, a computer program may include one or more instructions implementing methods/operations according to various embodiments of the disclosure. When a computer program is loaded into memory 130, the processor 110 may perform methods/operations according to various embodiments of the disclosure by executing one or more instructions.

The user interface 170 may receive commands, data, and information from external sources to the object re-identification apparatus 100. The user interface 170 may output the operation results of the object re-identification apparatus 100. For example, the user interface 170 may include keyboards, mice, monitors, and touchscreens.

The bus 190 provides communication functionality between the components of the object re-identification apparatus 100. The bus 190 may be implemented in various forms, such as address bus, data bus, and control bus.

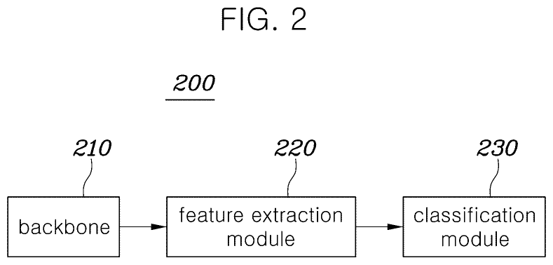

FIG. 2 is a block diagram illustrating function blocks of a processor 200 according to an embodiment of the disclosure.

The processor of FIG. 2 may be identical with the processor 110 in FIG. 1.

According to an embodiment, the processor 200 may perform object re-identification based on the input video sequences and may update the object re-identification model through learning from the input samples.

For this purpose, the processor 200 may be equipped with the object re-identification model. The operations of the processor 200 described below may be performed by the object re-identification model loaded onto the processor 200, and the object re-identification functionality of the object re-identification apparatus 100 may be achieved by the object re-identification model.

With reference to FIG. 2, the processor 200 (or object re-identification model) may be composed of a backbone 210, a feature extraction module 220, and a classification module 230, but the configuration of the processor (or object re-identification model) is not limited thereto.

The backbone 210 (or backbone network) may be configured based on the ResNet-50 model, but is not limited thereto. For example, models such as VGG16 and SpinNet may constitute the backbone.

The backbone 210 extracts features from the input video frames and may output the extracted features to the feature extraction module 220. Hereinafter, the features output from the backbone 210 to the feature extraction module 220 are referred to as the first features.

The feature extraction module 220 includes multiple expert modules and may segment the first features based on the activated expert modules among the multiple expert modules to output second features. Segmentation within the feature extraction module 220 may be performed multiple times.

According to an embodiment, the feature extraction module 220 includes multiple expert layers in a sequential relationship, and the multiple expert layers may contain multiple expert modules in a parallel relationship.

Each of the multiple expert layers may extract refined features from the input features based on the activated expert modules among the included multiple expert modules, thus generating refined features.

According to an embodiment, during the learning process based on samples, the expert module with the highest relevance to the samples may be activated among the multiple expert modules.

For example, when there are N expert layers, the output of the first layer of expert modules up to the output of the (N−1)^{th} layer of expert modules may be input to the next layer of expert modules, and the output of the last layer (N^{th} layer) of expert modules may be the output of the feature extraction module 220.

That is, the output of the last layer (N^{th} layer) of expert modules may correspond to the second feature output from the feature extraction module 220.

According to an embodiment, the output of the later expert layers (e.g., the expert layers in the 2^{nd} stage) may contain more refined features than the features contained in the output of the earlier expert layers (e.g., the expert layers in the 1^{st} stage).

Therefore, the features utilized in the training of the later expert modules may contain more refined information than the features utilized in the training of the earlier expert modules, and the later expert modules acquire expertise in discerning smaller differences more accurately compared to the earlier expert modules.

According to an embodiment, during the learning process of the feature extraction module 220, the expert modules may selectively learn spatial and temporal features.

The expert modules evaluate the importance of spatial and temporal aspects based on the input features and may learn spatial features or temporal features based on the evaluation results.

According to an embodiment, the feature extraction module 220 may automatically add new expert modules during the learning process. The addition of new expert modules may occur independently for each expert layer.

For this purpose, the feature extraction module 220 may include waiting expert modules associated with the expert layers, in addition to the expert modules.

According to an embodiment, when the relevance between awaiting expert module and a sample is greater than the relevance between other expert modules and the sample, the waiting expert module may be added to the corresponding expert layer. Furthermore, after adding the waiting expert module to the expert layer, the feature extraction module 220 may generate a new waiting expert module.

To clearly indicate the ability of the feature extraction module 220 to expand expert modules and to distinguish them from existing expert modules included in the expert layer, waiting expert modules included in the expert layer may be referred to as “expanded expert modules.”

It is preferred for the expert modules in the feature extraction module 220 to learn refined features to identify different identities. In this regard, it is preferred for the similarity between each expert module within the expert layer to be low.

According to an embodiment, the feature extraction module 220 may apply diversity loss to restrict the pairwise similarity of experts. Here, diversity loss may include loss for spatial features and loss for temporal features.

The feature extraction module 220 may vectorize spatial feature-related parameters and temporal feature-related parameters for each expert module.

Then, the feature extraction module 220 may calculate loss for spatial features (spatial feature loss) and loss for temporal features (temporal feature loss) based on pairwise cosine similarity for each expert layer.

However, the similarity calculation method employed by the feature extraction module 220 for loss computation is not restricted thereto.

The feature extraction module 220 may compute diversity loss by aggregating the calculated spatial feature loss and temporal feature loss for each expert layer.

The feature extraction module 220 may update the model parameters by applying diversity loss. According to an embodiment, the feature extraction module 220 may further apply conventional re-identification (Re-ID) losses, such as cross-entropy loss and batch hard triplet loss, to update the model parameters.

The methods for calculating re-identification loss based on cross-entropy and batch hard triplets are well-known techniques and will not be elaborated here.

The classification module 230 may classify classes based on the output of the feature extraction module 220. For example, the classification module 230 may perform classification using various classification algorithms, such as Naive Bayes Classifier, Support Vector Machine (SVM), Random Forest, Decision Tree, Gradient Boosting Tree (GBT), SGD Classifier, and AdaBoost.

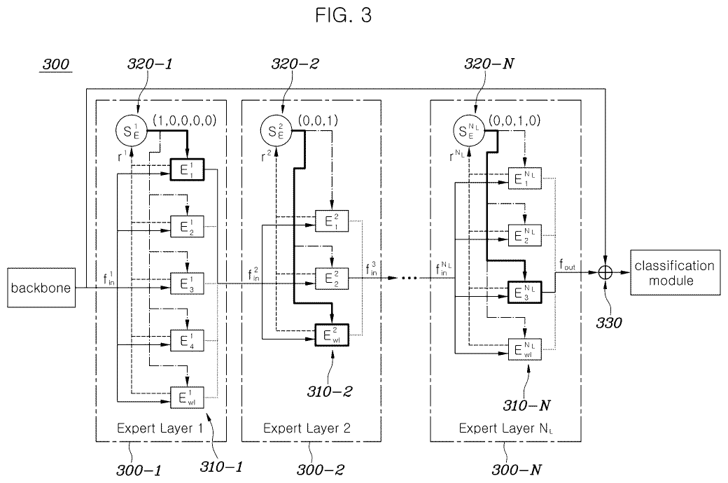

FIG. 3 is a diagram illustrating the detailed configuration of a feature extraction module 300 according to an embodiment of the disclosure.

The feature extraction module 300 of FIG. 3 may be identical with the feature extraction module 220 in FIG. 2.

With reference to FIG. 3, the feature extraction module 300 may include multiple expert layers 300-1 to 300-N in a sequential relationship.

According to an embodiment, each of the multiple expert layers 300-1 to 300-N may include multiple expert modules 310-1 to 310-N connected in parallel, along with selectors 320-1 to 320-N.

While FIG. 3 exemplifies the first-stage expert layer 300-1 including five expert modules, the second-stage expert layer 300-2 including three expert modules, and the N^{th}-stage expert layer 300-N including four expert modules, this configuration is not exhaustive.

Expert modules may be those generated during model implementation or those added during training.

In an embodiment, the fifth expert module

$${E}_{wl}^{1}$$

of the first-stage expert layer 300-1, the third expert module

$${E}_{wl}^{2}$$

of the second-stage expert layer 300-2, and the fourth expert module

$${E}_{w l}^{{N}_{L}}$$

of the N^{th}-stage may be “extended expert modules.”

Here, wl is a subscript indicating that the corresponding expert module is an “extended expert module.” As described above, “expanded expert modules” refer to expert modules added to the expert layer during training.

Expert layers 300-1 to 300-N may segment input features and output segmented features.

To achieve this, each expert layer 300-1 to 300-N may include activated expert modules

$${E}_{1}^{1} , {E}_{w l}^{2} , and {E}_{3}^{{N}_{L}}$$

from among multiple expert modules 310-1 to 310-N.

While FIG. 3 exemplifies the activation of the first expert module

$${E}_{1}^{1}$$

in the first-stage expert layer 300-1, the third expert module

$${E}_{w l}^{2}$$

in the second-stage expert layer 300-2, and the third expert module

$${E}_{3}^{{N}_{L}}$$

in the N^{th}-stage expert layer 300-N, the configuration is not an exhaustive.

As described above, the activation of expert modules is determined by the selectors 320 (320-1 to 320-N) during training.

During training, the selectors 320-1 to 320-N may receive relevance scores r^{l} from multiple expert modules 310-1 to 310-N within each expert layer 300-1 to 300-N, and activate the expert module with the highest relevance score r^{l} within the corresponding expert layer 300-1 to 300-N.

According to an embodiment, the selectors 320-1 to 320-N may generate a one-hot vector where only one index is set to 1 and the rest are set to 0 based on the input relevance scores r^{l}.

For example, the selectors 320-1 to 320-N may utilize the Cumbel-Softmax algorithm to evaluate relevance scores r^{l} and assign a value of 1 to the index of the highest relevance score while assigning 0 to the indices of the remaining expert modules, thus generating a one-hot vector.

Based on the one-hot vector, selectors 320-1 to 320-N may activate the expert module within the respective expert layer that has the highest relevance score r^{l}.

According to an example, the first expert module

$${E}_{1}^{1}$$

of the first expert layer 300-1 may segment the input features

$${f}_{in}^{1}$$

and produce segmented features

$${f}_{in}^{2} .$$

The third expert module

$${E}_{wl}^{2}$$

of the second expert layer 300-2 may segment the input features

$${f}_{{in}^{1}}^{1}$$

and produce segmented features

$${f}_{in}^{3} .$$

The third expert module

$${E}_{3}^{{N}_{L}}$$

of the Nth expert layer 300-N may segment the input features

$${f}_{in}^{{N}_{L}}$$

and produce segmented features fₒᵤₜ. Here, the features fₒᵤₜ output by the third expert module

$${E}_{3}^{{N}_{L}}$$

of the N^{th} expert layer 300-N may become the final output of the feature extraction module 300.

The output fₒᵤₜ of the N^{th} expert layer 300-N may be combined with the output

$${f}_{in}^{1}$$

of the backbone by the synthesizer 330 and then input to the classification module.

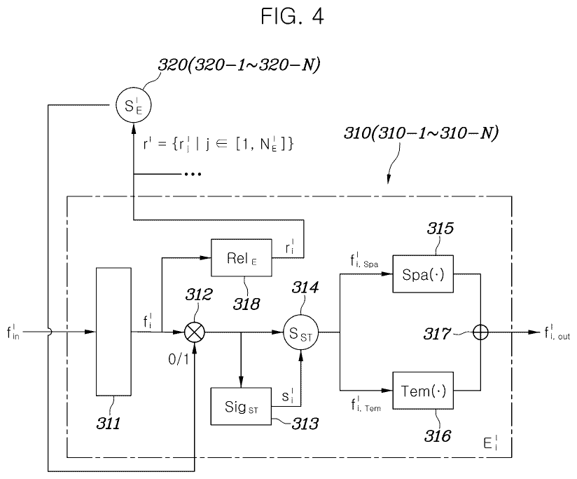

FIG. 4 is a diagram illustrating the detailed configuration of an expert module in FIG. 3.

With reference to FIG. 3 and FIG. 4, the expert module 310 (310-1 to 310-N)

$${E}_{i}^{l}$$

may input the incoming features

$${f}_{in}^{l}$$

into the mapping module 311 to map them to the feature space, and obtain the mapped features

$${f}_{i}^{l} .$$

Here, “l” is a subscript indicating that the expert module belongs to the l^{th} expert layer, and “i” is a subscript indicating that the expert module is the -th expert module within that expert layer.

Therefore,

$${E}_{i}^{l}$$

denotes the i-th expert module of the l^{th} expert layer.

The mapped features

$${f}_{i}^{l}$$

may selectively be inputted into the importance evaluation module 313 and the branching module 314 dewaiting on the activation status of the expert module 310.

For this purpose, the mapped features

$${f}_{i}^{l}$$

are inputted into the filtering module 312, which, based on the state vector values inputted from the selector 320, may either pass or block the mapped features

$${f}_{i}^{l}$$

to the downstream.

Here, the state vector values are outputted from the selector 320 to determine the activation status of the respective expert module 310 and may have values of 0 or 1.

When the state vector value is 1 (i.e., the respective expert module 310 is activated), the filtering module 312 may output the mapped features

$${f}_{i}^{l}$$

to the downstream, i.e., the importance evaluation module 313 and the branching module 314.

When the state vector value is 0 (i.e., the corresponding expert module 310 is deactivated), the filtering module 312 blocks the mapped features

$${f}_{i}^{l} ,$$

thereby potentially terminating the operation of the corresponding expert module 310.

The importance evaluation module 313 may receive the mapped features

$${f}_{i}^{l}$$

as input and produce an importance vector

$${s}_{i}^{l}$$

for the mapped features

$${f}_{i}^{l} .$$

According to an embodiment, the importance evaluation module 313 may utilize max-pooling and fully-connected layers to output an importance vector

$${s}_{i}^{l}$$

containing a single importance value for the mapped features

$${f}_{i}^{l} .$$

Here, the importance value (or importance vector) may indicate whether the mapped features

$${f}_{i}^{l}$$

are more important in spatial or temporal aspects.

The max-pooling and fully-connected layers are well-known techniques in the technical field of the present invention, and detailed explanations thereof are omitted here.

The importance vector

$${s}_{i}^{l}$$

may be inputted into the branching module 314.

The branching module 314 may receive both the mapped features

$${f}_{i}^{l}$$

and the importance vector

$${s}_{i}^{l}$$

as inputs.

The branching module 314 may generate a binary decision vector based on the importance vector

$${s}_{i}^{l}$$

and, based on this binary decision vector, may output the mapped features

$${f}_{i}^{l}$$

to either the spatial feature extraction module 315 or the temporal feature extraction module 316.

The path between the branching module 314 and the spatial feature extraction module 315 may be referred to as the “spatial feature channel,” while the path between the branching module 314 and the temporal feature extraction module 316 may be referred to as the “temporal feature channel.”

For example, the branching module 314 may utilize a discretization method such as semantic hashing to generate a binary decision vector, but the algorithm for generating the binary decision vector is not limited thereto.

The branching module 314 may output the mapped features

$${f}_{i}^{l}$$

to the spatial feature extraction module 315 when the value of the binary decision vector is 1. Here,

$${f}_{i , Spa}^{l}$$

may refer to the “mapped features

$${f}_{i}^{l ″}$$

(hereinafter referred to as spatially branched features) branched to the spatial feature extraction module 315 (or spatial feature channel).

The branching module 314 may output the mapped features

$${f}_{i}^{l}$$

to the temporal feature extraction module 316 when the value of the binary decision vector is 0.

$${f}_{i , Tem}^{l}$$

may refer to the “mapped features

$${f}_{i}^{l ″}$$

(hereinafter referred to as temporally branched features) branched to the temporal feature extraction module 316 (or temporal feature channel).

The spatial feature extraction module 315 may extract refined features from spatially-branched features

$${f}_{i , Spa}^{l} .$$

For example, the spatial feature extraction module 315 may be structured with a 1×3×3 convolutional layer to extract spatial information, although the implementation of the spatial feature extraction module 315 is not limited thereto.

The temporal feature extraction module 316 may extract refined features from temporally-branched features

$${f}_{i , Tem}^{l} .$$

For example, the temporal feature extraction module 316 may be structured with a 3×1×1 convolutional layer to extract temporal information, although this implementation of the temporal feature extraction module 316 is not limited thereto.

Therefore, for a single video frame, the expert module may extract segmented spatial features or segmented temporal features. That is, for one video frame, the expert module outputs either segmented spatial features or segmented temporal features, but not both.

The synthesizer 317 may combine the outputs of the spatial feature extraction module 315 and the temporal feature extraction module 316 to generate an output.

The output of the synthesizer 317 may be the output

$${f}_{i , out}^{l}$$

of the corresponding expert module 310.

Meanwhile, during the training process, the mapped features

$${f}_{i}^{l}$$

may be input to the relevance evaluation module 318.

The relevance evaluation module 318 may evaluate the relevance between the corresponding expert module 310 and the sample.

According to an embodiment, the relevance evaluation module 318 may generate relevance values using max-pooling and fully-connected layers, and obtain relevance scores

$${r}_{i}^{l}$$

using the tanh function.

The relevance evaluation module 318 may output the relevance scores

$${r}_{i}^{l}$$

to the selector 320 of the corresponding expert layer.

Accordingly, the selector 320 may obtain the relevance scores

$${r}^{l} = \{ {r}_{1}^{l} , {r}_{2}^{l} , … , {r}_{{N}_{E}}^{l} \}$$

for all expert modules within the corresponding expert layer, and based on this, may activate the expert module within the expert layer with the highest relevance score r^{l}.

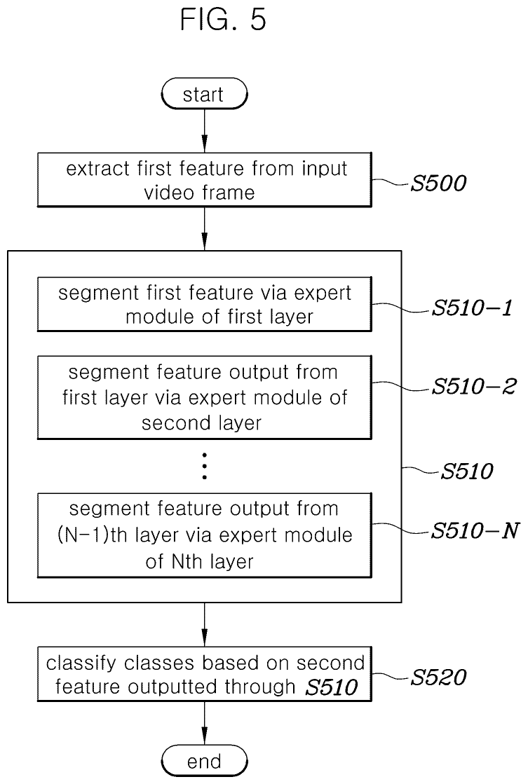

FIG. 5 is a flowchart illustrating an object re-identification method according to an embodiment of the disclosure.

The stepwise operations illustrated in FIG. 5 may be performed by the object re-identification apparatus 100 or object re-identification model) described with reference to FIG. 1, FIG. 2, FIG. 3, and FIG. 4.

With reference to FIG. 1, FIG. 2, FIG. 3, FIG. 4, and FIG. 5, the backbone 210 may extract the first feature from the input video frame at operation S500.

Subsequently, the feature extraction module 220 may refine the first feature to generate the second feature based on the expert modules 310-1 to 310-N within the multiple expert layers 300-1 to 300-N at operation S510.

According to an embodiment, the expert modules 310-1 to 310-N may be the expert modules activated by the selector 320 within the expert layers 300-1 to 300-N during training, based on their highest relevance with the samples.

According to an embodiment, the expert modules 310-1 to 310-N may be expert modules generated during model implementation or expert modules added during training.

In operation S510, segmentation by multiple expert modules 310-1 to 310-N may be performed multiple times across operations S510-1 to S510-N.

In each of operations S510-1 to S510-N, the expert modules 310-1 to 310-N may map the input features into the feature space and evaluate whether the mapped features are important in the spatial aspect or the temporal aspect.

Based on the evaluation, the expert modules 310-1 to 310-N may extract spatially segmented features or temporally segmented features from the mapped features.

Afterward, the classification module 230 may classify, at operation S520, the classes based on the second features outputted through operation S510.

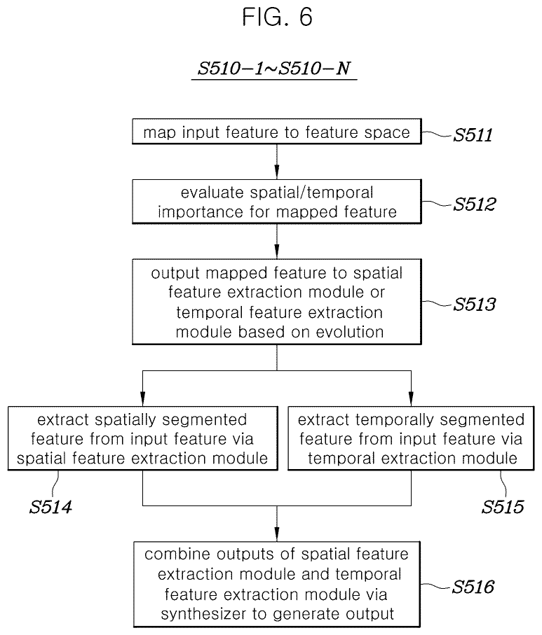

FIG. 6 is a flowchart illustrating detailed operations at S510-1 to S510-N in FIG. 5.

With reference to FIG. 3, FIG. 4, and FIG. 6, the mapping module 311 may map the input features

$${f}_{in}^{l}$$

to a feature space and obtain the mapped features

$${f}_{i}^{l}$$

in operation S511.

The mapped features

$${f}_{i}^{l}$$

may be inputted into the importance evaluation module 313 and the branching module 314.

The importance evaluation module 313 may evaluate in operation S512 whether the mapped features

$${f}_{i}^{l}$$

are more important in the spatial aspect or in the temporal aspect.

In operation S512, the importance evaluation module 313 may output an importance vector

$${s}_{i}^{l}$$

containing a single importance value for the mapped features

$${f}_{i}^{l} .$$

The importance vector

$${s}_{i}^{l}$$

may be inputted into the branching module 314.

The branching module 314 receives the mapped features

$${f}_{i}^{l}$$

and the importance vector

$${s}_{i}^{l}$$

as inputs and selectively output to the spatial feature extraction module 315 or the temporal feature extraction module 316 based on the importance vector

$${s}_{i}^{l}$$

in operation S513.

In operation S513, the branching module 314 may generate a binary decision vector based on the importance vector

$${s}_{i}^{l}$$

and output the mapped features

$${f}_{i}^{l}$$

to either the spatial feature extraction module 315 or the temporal feature extraction module 316 based on this binary decision vector.

When the value of the binary decision vector is 1 in operation S513, the branching module 314 may output the mapped features

$${f}_{i}^{l}$$

to the spatial feature extraction module 315.

When the value of the binary decision vector is 0 in operation S513, the branching module 314 may output the mapped features

$${f}_{i}^{l}$$

to the temporal feature extraction module 316.

Sequentially, the spatial feature extraction module 315 may extract spatially segmented features from the input features

$${f}_{i , Spa}^{l}$$

in operation S514, or the temporal feature extraction module 316 may extract temporally segmented features from the input features

$${f}_{i , Tem}^{l}$$

in operation S515.

Afterward, the synthesizer 317 may combine the outputs of the spatial feature extraction module 315 and the temporal feature extraction module 316 to generate an output in operation S516.

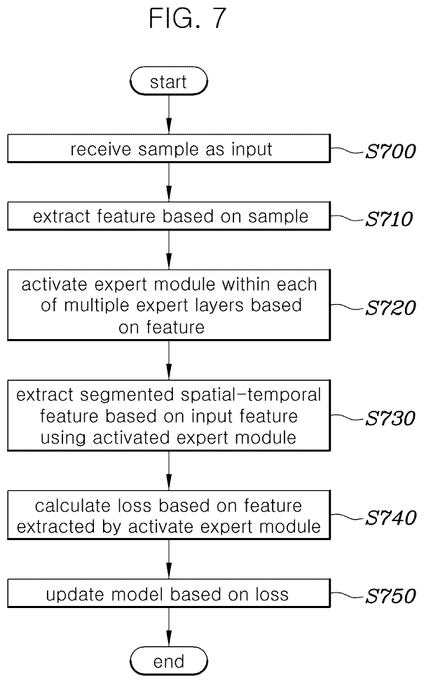

FIG. 7 is a flowchart illustrating a method for training an object re-identification model according to an embodiment of the disclosure.

The object re-identification apparatus 100 may perform training for the object re-identification model based on preset model parameters.

According to an embodiment, the object re-identification apparatus 100 may receive a sample in operation S700 and extract features based on the sample using the backbone 210 in operation S710.

Next, the object re-identification apparatus 100 may activate expert modules for each of the multiple expert layers based on the features in operation S720.

In operation S720, the first expert layer among the multiple expert layers may activate one of the multiple expert modules based on the features input from the backbone 210.

In operation S720, the expert layers other than the first one may activate one of the multiple expert modules based on the features outputted from the preceding expert layer.

In operation S720, each expert module within multiple expert layers evaluates the relevance of the input features and the relevance scores of the expert modules using the relevance evaluation module 318, allowing the selector 320 of each expert layer to activate the expert module with the highest relevance score within that layer.

After activating the expert modules for each of the multiple expert layers, the object re-identification apparatus 100 may extract segmented features based on the features extracted from the input samples using the activated expert modules within the multiple expert layers in operation S730.

In operation S730, the activated expert modules may extract spatially segmented features (segmented spatial features) or temporally segmented features (segmented temporal features) from the input features.

In operation S730, the activated expert modules may evaluate the spatial-temporal importance of the input features and extract segmented spatial features or segmented temporal features based on the evaluation results.

Afterward, the object re-identification apparatus 100 may compute the loss based on the features extracted by the activated expert modules in operation S740 and update the model based on the loss in operation S750.

Here, the loss is computed based on the features extracted by the activated expert modules, and model updates may be performed for the activated expert modules.

According to an embodiment of the disclosure, the object re-identification apparatus 100 may compute diversity loss according in operation S740.

According to an embodiment, the object re-identification apparatus 100 may vectorize spatial feature-related parameters and temporal feature-related parameters for each expert module.

Then, the object re-identification apparatus 100 may compute the loss for spatial features (spatial feature loss) and the loss for temporal features (temporal feature loss) by calculating the pairwise cosine similarity of vectorized spatial feature parameters and temporal feature parameters for each expert layer.

The object re-identification apparatus 100 may compute diversity loss by aggregating the calculated spatial feature loss and temporal feature loss for each expert layer.

In operation S740, the object re-identification apparatus 100 may additionally compute existing re-identification (Re-ID) losses such as cross-entropy loss and batch hard triplet loss.

Table 1 shows the results of testing the object re-identification model according to an embodiment of the disclosure and the conventional object re-identification model.

TABLE 1

| | MARS | | | | LS-VID | |
|---|---|---|---|---|---|---|
| Method | mAP | rank-1 | rank-5 | Rank-20 | mAP | rank-1 |
| KTP | 73.3 | 84.0 | 93.7 | — | — | — |
| Attribute | 78.2 | 87.0 | 95.4 | 98.7 | — | — |
| MGRA | 85.9 | 88.8 | 97.0 | 98.5 | — | — |
| STGCN | 83.7 | 89.9 | — | — | — | — |
| TCLNet-tri | 85.1 | 89.8 | — | — | — | — |
| BiCnet-TKS | 86.0 | 90.2 | — | — | 75.1 | 84.6 |
| GRL | 84.8 | 91.0 | 96.7 | 98.4 | — | — |
| CTL | 86.7 | 91.4 | 96.8 | 98.5 | — | — |
| STRF | 86.1 | 90.3 | — | — | — | — |
| DenseIL | 87.0 | 90.8 | 97.1 | 98.8 | — | — |
| STMN | 84.5 | 90.5 | — | — | 69.2 | 82.1 |
| PSTA | 85.8 | 91.5 | — | — | — | — |
| SINet | 86.2 | 91.0 | — | — | 79.6 | 87.4 |
| Ours | 87.0 | 91.6 | 97.4 | 98.9 | 81.0 | 88.3 |

The tests were conducted based on the public large-scale datasets MARS and LS-VID, with evaluations including mAP, rank-1, rank-5, and rank-20 for the MARS dataset, and mAP and rank-1 for the LS-VID dataset.

As can be seen in Table 1, the performance of the object re-identification model according to an embodiment of the disclosure is superior to the performance of the conventional object re-identification model.

Although the disclosure has been illustrated and described in connection with specific embodiments, it will be obvious to those skilled in the art that various modification and changes can be made thereto without departing from the spirit of the disclosure or the scope of the appended claims.

What is claimed is:

1. An object re-identification apparatus, the apparatus comprising:
a memory configured to store an object re-identification model; and
a processor configured to execute the model,
wherein the processor is configured to:
extract a first feature from a video frame input, and
segment the first feature into a second feature based on an expert module within multiple expert layers in a sequential relationship, and
classify the second feature in the object re-identification model,
wherein the expert module is a single expert module activated among multiple expert modules within a single expert layer.

2. The apparatus of claim 1, wherein the expert module is an expert module generated during implementation of the model or an expert model added during training.

3. The apparatus of claim 1, wherein the expert module within a first expert layer is configured to extract segmented features based on the first feature, and the expert modules within the remaining expert layers are configured to extract segmented features based on the features output from the expert module of the preceding expert layer.

4. The apparatus of claim 1, wherein the expert module has the highest relevance to the input video among multiple expert modules within the single expert layer.

5. The apparatus of claim 1, wherein the expert module is selectively configured to extract a spatially segmented feature or a temporally segmented feature based on spatial-temporal importance of an input feature.

6. The apparatus of claim 1, wherein the expert module comprises:
an importance evaluation module configured to output an importance vector based on the input feature;
a branching module configured to output the input feature to a spatial feature channel or a temporal feature channel based on the importance vector;
a spatial feature extraction module configured to extract spatial features segmented based on the feature input through the spatial feature channel; and
a temporal feature extraction module configured to extract temporal features segmented based on the feature input through the temporal feature channel.

7. The apparatus of claim 5, wherein the importance evaluation module is configured to output the importance vector including an importance value for the input feature using max-pooling and a fully-connected layer.

8. The apparatus of claim 5, wherein the branching module is configured to generate a binary decision vector based on the importance vector, output the input feature to the spatial feature channel based on the binary decision vector being 1, and output the input feature to the temporal feature channel based on the binary decision vector being 0.

9. The apparatus of claim 1, wherein the processor comprises a selector configured to activate one of the multiple expert modules within the single expert layer based on relevance scores of the multiple expert modules within the single expert layers during training.

10. The apparatus of claim 1, wherein the processor further comprises a waiting expert module associated with the single expert layer, the waiting expert module being selectively included in the single expert layer during training.

11. An object re-identification method implemented by a processor executing an object re-identification model stored in memory, the method comprising:
extracting, by the processor, a first feature from an input video frame;
extracting, by the processor, a second feature by segmenting the first feature based on an expert module within multiple expert layers in a sequential relationship; and
classifying, by the processor, the second feature in the object re-identification model,
wherein the expert module is a single expert module activated among multiple expert modules within a single expert layer.

12. The method of claim 11, wherein extracting the second feature comprises:
extracting, by the expert module within a first expert layer, segmented features based on the first feature; and
extracting, by expert modules within the remaining expert layers, segmented features based on the feature output from the expert module of the preceding expert layer, the feature extracted by the expert module within the last expert layer being the second feature.

13. The method of claim 11, wherein extracting the second feature comprises selectively extracting, by the expert module, a spatially segmented feature or a temporally segmented feature based on spatial-temporal importance of an input feature.

14. The method of claim 11, wherein extracting the second feature comprises:
extracting an importance vector based on an input feature;
outputting the input feature to a spatial feature channel or a temporal feature channel based on the importance vector; and
extracting spatial features segmented based on the feature input through the spatial feature channel or temporal features segmented based on the feature input through the temporal feature channel.

15. The method of claim 14, wherein extracting the second feature comprises generating a binary decision vector based on an importance vector, and the outputting of the input feature to the spatial feature channel or temporal feature channel comprises outputting the input feature to the spatial feature channel based on the binary decision vector being 1 and outputting the input feature to the temporal feature channel based on the binary decision vector being 0.

16. A model learning method of an object re-identification apparatus, the method comprising:
extracting, by a processor, a feature based on an input sample;
activating, by the processor, an expert module for each of multiple expert layers in a sequential relationship based on the feature;
after activating the expert module, extracting, by the processor, segmented features based on the feature extracted from the input sample using the activated expert module;
calculating, by the processor, loss based on the segmented features; and
updating, by the processor, the model based on the loss.

17. The method of claim 16, wherein activating the expert module comprises:
activating, by a first expert layer among multiple expert layers, one of multiple expert modules based on the feature; and
activating, by the remaining expert layers among the multiple expert layers, one of the multiple expert modules based on the feature output from a preceding expert layer.

18. The method of claim 16, wherein activating the expert module comprises:
evaluating, by the multiple expert module of each of the multiple expert layers, an input feature and a relevance score of the expert module; and
activating, by a selector of each of the multiple expert modules, the expert module with the highest relevance score within the corresponding expert layer.

19. The method of claim 16, wherein extracting the segmented features comprises:
evaluating, by the activated expert module, spatial-time importance of the input feature; and
extracting spatially segmented features or temporally segmented features based on the evaluation.

20. The method of claim 19, wherein calculating the loss comprises:
vectorizing a spatial feature parameter or temporal feature parameter output from the activated expert module; and
calculating loss for the spatial feature and loss for the temporal feature by computing the pairwise cosine similarity based on the vectorized spatial and temporal feature parameters for each expert layer.
